(19) United States
(12) Patent Application Publication
(10) Pub. No.: US 2024/0350925 A1
(43) Pub. Date: Oct. 24, 2024

(54) METHOD AND APPARATUS FOR DISPLAYING CONTEST RANKING, MEDIUM, ELECTRONIC DEVICE, AND PROGRAM PRODUCT

(71) Applicant: Tencent Technology (Shenzhen) Company Limited, Shenzhen (CN)

(72) Inventor: Ye KUANG, Shenzhen (CN)

(21) Appl. No.: 18/761,146

(22) Filed: Jul. 1, 2024

Related U.S. Application Data
(63) Continuation of application No. PCT/CN2023/084018, filed on Mar. 27, 2023.

(30) Foreign Application Priority Data
May 13, 2022 (CN) 202210521942.9

(51) Int. Cl. A63F 13/798

(52) U.S. Cl. CPC A63F 13/798

(57) ABSTRACT

This application discloses a method for displaying a contest ranking performed by a computer device. The method includes: running a target virtual task of a contest in which at least three virtual accounts participate; after determining that a target virtual account satisfies a contest end condition, obtaining battle attribute values of the remaining virtual accounts still participating in the target virtual task, wherein each battle attribute value corresponds to a current battle result of a corresponding virtual account participating in the target virtual task; before any of the remaining virtual accounts satisfies the contest end condition: determining, based on the battle attribute values of the remaining virtual accounts, a target contest ranking of the target virtual account in the target virtual task; and displaying the target contest ranking of the target virtual account to the user of the computer device.

### CROSS-REFERENCE TO RELATED APPLICATIONS

This application is a continuation application of PCT Patent Application No. PCT/CN2023/084018, entitled “METHOD AND APPARATUS FOR DISPLAYING CONTEST RANKING, MEDIUM, ELECTRONIC DEVICE, AND PROGRAM PRODUCT” filed on Mar. 27, 2023, which claims priority to Chinese Patent Application No. 202210521942.9, entitled “METHOD FOR DISPLAYING CONTEST RANKING, STORAGE MEDIUM, AND ELECTRONIC DEVICE” filed on May 13, 2022, both of which are incorporated herein by reference in their entirety.

### FIELD OF THE TECHNOLOGY

This application relates to the computer field, and specifically, to displaying of a contest ranking.

### BACKGROUND OF THE DISCLOSURE

In a virtual game scene, a contest ranking of a player is usually displayed after game contests of all players end. However, the manner of displaying the contest ranking is not timely enough, especially in some multiplayer turn-based virtual game scenes.

For example, after a player is eliminated early in a current turn, a contest ranking of the player can be determined only after another player is eliminated, or after a plurality of turns of a virtual game all end. As a result, there is a problem that displaying of the contest ranking is not timely enough.

For the foregoing problem, no effective solution is currently provided.

### SUMMARY

Embodiments of this application provide a method and an apparatus for displaying a contest ranking, a medium, an electronic device, and a program product, to resolve at least a technical problem that displaying of the contest ranking is not timely enough.

According to an aspect of the embodiments of this application, a method for displaying a contest ranking is provided. The method includes: running a target virtual task of a contest in which at least three virtual accounts participate, the at least three virtual account including a target virtual account controlled by a user of the computer device; withdrawing the target virtual account from participating the target virtual task after determining that the target virtual account satisfies a contest end condition; obtaining battle attribute values of remaining virtual accounts other than the target virtual account of the at least three virtual accounts still participating in the target virtual task, wherein each battle attribute value corresponds to a current battle result of a corresponding virtual account participating in the target virtual task; before any of the remaining virtual accounts satisfies the contest end condition: determining, based on the battle attribute values of the remaining virtual accounts, a target contest ranking of the target virtual account in the target virtual task; and displaying the target contest ranking of the target virtual account to the user of the computer device.

According to still another aspect of the embodiments of this application, a computer device is further provided. The electronic device includes a memory, a processor, and a computer program stored in the memory and executable on the processor. The processor causes the computer device to perform the method for displaying a contest ranking according to the foregoing aspects through the computer program.

According to still another aspect of the embodiments of this application, a non-transitory computer-readable storage medium is further provided. The storage medium is configured to store a computer program, and the computer program, when executed by a processor a computer device, is configured for performing the method for displaying a contest ranking according to the foregoing aspects.

In the embodiments of this application, the target virtual task in which the at least three virtual accounts participate is run in the client. During the running of the target virtual task, when the target virtual account using the client satisfies the contest end condition, the battle attribute values of the remaining virtual accounts other than the target virtual account in the at least three virtual accounts are obtained. The battle attribute values include the target battle attribute value of the virtual account that has not satisfied the contest end condition in the remaining virtual accounts. The battle attribute value is related to the battle result of the corresponding virtual account in the target virtual task. The target battle attribute value is the minimum battle attribute value corresponding to the corresponding virtual account when the battle result thereof is a failure. The target contest ranking of the target virtual account in the target virtual task when the target virtual account satisfies the contest end condition is determined based on the battle attribute values. The target contest ranking is displayed in the prompt information triggered when the target virtual account satisfies the contest end condition. The battle attribute value of each virtual account participating in the target virtual task is used to achieve an objective of estimating the target contest ranking of the target virtual account in the target virtual task when the target virtual account satisfies the contest end condition. In addition, the target contest ranking is estimated by using the minimum battle attribute value corresponding to the virtual account that has not satisfied the contest end condition when the battle result thereof is a failure, so that accuracy of estimating the target contest ranking is improved. In this way, before all contests of the target virtual task end, a player can obtain a more accurate target contest ranking when the player satisfies the contest end condition, thereby implementing a technical effect of improving timeliness of displaying the contest ranking, and resolving a technical problem that the displaying of the contest ranking is not timely enough.

### BRIEF DESCRIPTION OF THE DRAWINGS

FIG. 1 is a schematic diagram of an application environment of an exemplary method for displaying a contest ranking according to an embodiment of this application.

FIG. 2 is a schematic flowchart of an exemplary method for displaying a contest ranking according to an embodiment of this application.

FIG. 3 is a schematic diagram of an exemplary method for displaying a contest ranking according to an embodiment of this application.

FIG. 4 is a schematic diagram of another exemplary method for displaying a contest ranking according to an embodiment of this application.

FIG. 5 is a schematic diagram of another exemplary method for displaying a contest ranking according to an embodiment of this application.

FIG. 6 is a schematic diagram of another exemplary method for displaying a contest ranking according to an embodiment of this application.

FIG. 7 is a schematic diagram of another exemplary method for displaying a contest ranking according to an embodiment of this application.

FIG. 8 is a schematic diagram of another exemplary method for displaying a contest ranking according to an embodiment of this application.

FIG. 9 is a schematic diagram of another exemplary method for displaying a contest ranking according to an embodiment of this application.

FIG. 10 is a schematic diagram of another exemplary method for displaying a contest ranking according to an embodiment of this application.

FIG. 11 is a schematic diagram of another exemplary method for displaying a contest ranking according to an embodiment of this application.

FIG. 12 is a schematic diagram of an apparatus for displaying a contest ranking according to an embodiment of this application.

FIG. 13 is a schematic diagram of a structure of an electronic device according to an embodiment of this application.

### DESCRIPTION OF EMBODIMENTS

To make a person skilled in the art better understand solutions of this application, the following clearly and completely describes the technical solutions in embodiments of this application with reference to the accompanying drawings in embodiments of this application. Apparently, the described embodiments are merely a part rather than all of the embodiments of this application. All other embodiments obtained by a person of ordinary skill in the art based on embodiments of this application without creative efforts shall fall within the protection scope of this application.

In the specification, claims, and accompanying drawings of this application, terms “first”, “second”, and the like are intended to distinguish between similar objects, but do not necessarily indicate a specific order or sequence. Data used in this way may be interchanged in an appropriate case, so that embodiments of this application described herein can be implemented in other orders than the order illustrated or described herein. In addition, terms “include”, “have”, and any other variants thereof are intended to cover a non-exclusive inclusion. For example, a process, method, system, product, or device that includes a list of operations or units is not limited to those expressly listed operations or units, but may include other operations or units not expressly listed or inherent to the process, method, product, or device.

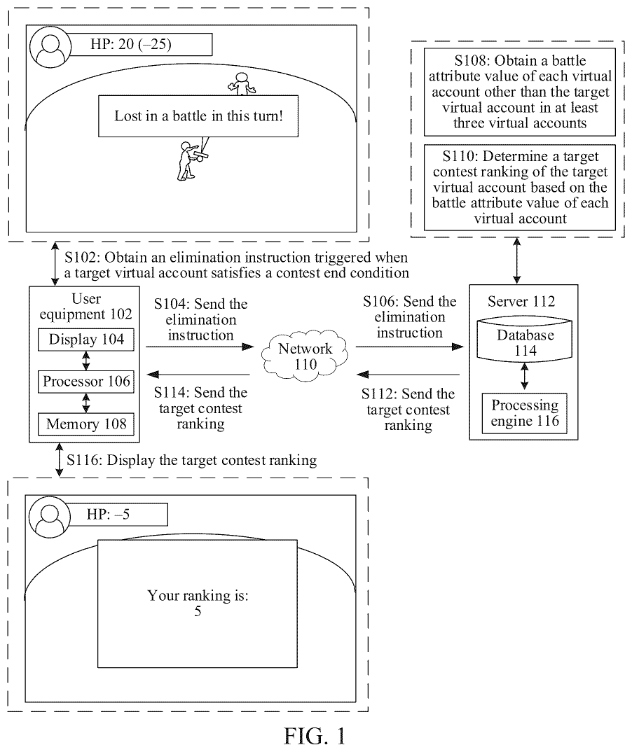

According to an aspect of embodiments of this application, a method for displaying a contest ranking is provided. In some embodiments, in an optional implementation, the method for displaying a contest ranking may be applied to, but is not limited, to an environment shown in FIG. 1. A computer device may include, but is not limited to, user equipment 102 and a server 112. The user equipment 102 may include, but is not limited to, a display 104, a processor 106, and a memory 108. The server 112 includes a database 114 and a processing engine 116.

A specific process may include the following operations.
Operation S102: The user equipment 102 obtains an elimination instruction triggered when a target virtual account satisfies a contest end condition.
Operations S104 to S106: Send the elimination instruction to the server 112 through a network 110.
Operations S108 to S110: The server 112 searches the database for a battle attribute value of each virtual account other than the target virtual account in at least three virtual accounts that participate in a target virtual task, and determines a target contest ranking of the target virtual account based on the battle attribute value of each virtual account by using the processing engine.
Operations S112 to S116: The target contest ranking is sent to the user equipment 102 through the network 110, and the user equipment 102 displays the target contest ranking on the display 104 by using the processor 106 and stores the target contest ranking in the memory 108.

In addition to the example shown in FIG. 1, the foregoing operations may be completed through assistance of the server. To be specific, the server performs operations such as obtaining the battle attribute value and determining the target contest ranking, thereby reducing a processing pressure on the server. The user equipment 102 includes, but is not limited to, a handheld device (such as a mobile phone), a laptop computer, a desktop computer, a vehicle-mounted device, or the like. A specific implementation of the user equipment 102 is not limited in this application.

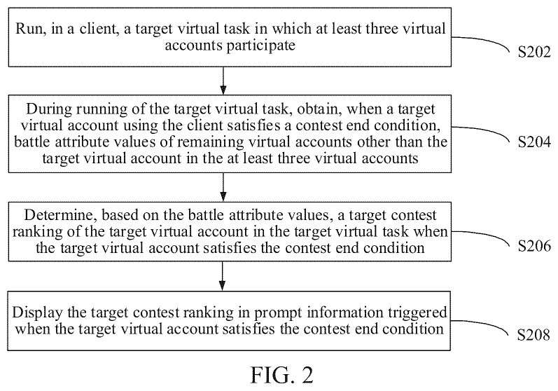

In some embodiments, in an optional implementation, as shown in FIG. 2, a method for displaying a contest ranking includes the following operations.
S202: Run, in a client, a target virtual task in which at least three virtual accounts participate.
S204: During running of the target virtual task, obtain, when a target virtual account using the client satisfies a contest end condition, battle attribute values of remaining virtual accounts other than the target virtual account in the at least three virtual accounts, where the battle attribute values include a target battle attribute value of a virtual account that has not satisfied the contest end condition in the remaining virtual accounts, the battle attribute value is related to a battle result of a corresponding virtual account in the target virtual task, and the target battle attribute value is a minimum battle attribute value corresponding to the corresponding virtual account when a battle result thereof is a failure.
S206: Determine, based on the battle attribute values, a target contest ranking of the target virtual account in the target virtual task when the target virtual account satisfies the contest end condition.
S208: Display the target contest ranking in prompt information triggered when the target virtual account satisfies the contest end condition.

In some embodiments, in this embodiment, the method for displaying a contest ranking may be applied to, but is not limited to, a virtual game scene of a multiplayer turn-based arena game. For example, eight players (virtual accounts) participate in the game scene, the game is divided into a plurality of turns, and each turn includes a preparation stage and a battle stage. In the preparation stage, the player configures a related to-be-battled element. After entering the battle stage, the players are paired up and have a battle. When all battle elements of one party are eliminated, the party is considered to be a failure (a battle result). A health point (battle attribute value) of the losing part is deducted. A turn is constantly repeated to match a new opponent, and until a health value of a player is less than or equal to 0, the player is considered to be eliminated from the game (satisfies the contest end condition). One last remaining player finally wins the game, and a contest ranking is the first place. Rankings (contest rankings) of the other players are determined based on health points (battle attribute values) remained when the other players are eliminated from the game.

It can be learned that, in the foregoing game scene, the manner of determining the contest ranking is complex. As a result, in a related art, a contest ranking of each player is counted usually after one or more winners of the entire game are determined. However, if a player is eliminated from the game early, the player can determine a contest ranking thereof only after the final winner of the game is determined, and timeliness is poor. However, if a contest ranking is directly displayed to the eliminated player, accuracy of the contest ranking cannot be ensured, and the contest ranking displayed to the player is probably wrong, causing poor reliability.

Further, for the problem that the timeliness and the reliability of displaying the contest ranking cannot be ensured simultaneously, this embodiment provides a manner in which the contest ranking of the eliminated player is displayed in a timely manner, and the contest ranking of the eliminated player is determined based on a limit attribute value of a player that has not been eliminated when the player is eliminated, to improve the reliability of displaying the contest ranking, thereby implementing a technical effect of simultaneously ensuring both the timeliness and the reliability of displaying the contest ranking.

In some embodiments, in this embodiment, the target virtual task may be understood as, but is not limited to, one round of virtual task, and the contest end condition may be understood as, but is not limited to, an end condition of the round of virtual task. One round of virtual task may include, but is not limited to, at least one turn of battle task, and the battle result may be understood as, but is not limited to, a task result of the at least one turn of battle task.

In some embodiments, in this embodiment, the battle attribute value is related to the battle result of the virtual account in the target virtual task. For example, when the battle result of the virtual account is a failure, the battle attribute value of the virtual account is reduced, and when the battle result of the virtual account is a success, the battle attribute value of the virtual account is unchanged or increased.

In some embodiments, in this embodiment, the target battle attribute value is the minimum battle attribute value corresponding to the virtual account when the battle result thereof is a failure. For example, a quantity of battle attribute values of the virtual account are deducted when the battle result thereof is a failure, and the quantity of battle attribute values are related to a target attribute value of a battle object of the virtual account.

Further, for example, in some embodiments, to obtain a target battle attribute value of a virtual account A, a battle object of the virtual account A is first determined to be a virtual account B. Then, before a battle between the virtual account A and the virtual account B ends, it is assumed that a battle result of the virtual account A is a failure, a target attribute value of the virtual account B is further obtained, and a quantity of battle attribute values are determined based on the target attribute value. Then the quantity of battle attribute values are deducted from an initial battle attribute value of the virtual account A to obtain the target battle attribute value of the virtual account A. To determine a limit value of the target battle attribute value, when the target attribute value may be consumed due to the battle, it may be assumed, but is not limited to, that the target attribute value is not consumed, and then the target battle attribute value of the virtual account A is determined based on the target attribute value that is not consumed, to obtain the limit value of the target battle attribute value.

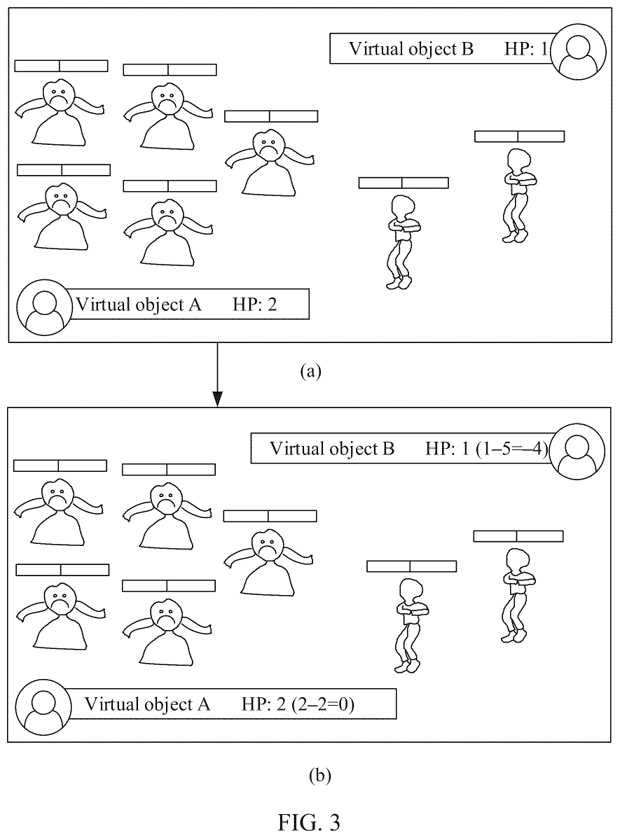

Specifically, it is assumed that five virtual objects controlled by the virtual account A is to battle with two virtual objects controlled by the virtual account B. Until all virtual objects of one party are eliminated, the party is determined to be a losing party, and a target quantity of battle attribute values of the losing party are deducted. The target quantity may be but is not limited to a remaining quantity of virtual objects controlled by a winner party. In some embodiments, as shown in FIG. 3(a), the initial battle attribute value of the virtual account A is 2, and an initial battle attribute value of the virtual account B is 1. Further, as shown in FIG. 3(b), the target battle attribute value of the virtual account A may be determined as 0 (2−2=0), and a target battle attribute value of the virtual account B may be determined as −4 (1−5=−4).

In some embodiments, in this embodiment, the target contest ranking of the target virtual account in the target virtual task when the target virtual account satisfies the contest end condition that is determined based on the battle attribute values of the remaining virtual accounts other than the target virtual account in the at least three virtual accounts may be, but is not limited to a contest ranking before or after the contest ranking of the target virtual account when the target virtual account is determined, based on the battle attribute values of the remaining virtual accounts, to satisfy the contest end condition. For example, when the target virtual account satisfies the contest end condition, the remaining virtual accounts may be approximately classified into four categories of virtual accounts, such as a virtual account A, a virtual account B, a virtual account C, and a virtual account D. The virtual account A does not satisfy the contest end condition and a target battle attribute value of the virtual account A also does not satisfy the contest end condition. The virtual account B does not satisfy the contest end condition, but a target battle attribute value of the virtual account B satisfies the contest end condition, and the target battle attribute value of the virtual account B is greater than an end battle attribute value of the target virtual account when the target virtual account satisfies the contest end condition. The virtual account C has satisfied the contest end condition (in other words, a battle attribute value of the virtual account C has been determined, and a contest ranking relationship between the virtual account C and the target virtual account can be determined). The virtual account D does not satisfy the contest end condition, but a target battle attribute value of the virtual account D satisfies the contest end condition, and the target battle attribute value of the virtual account D is less than or equal to the end battle attribute value of the target virtual account when the target virtual account satisfies the contest end condition.

Further, in this embodiment, the virtual account A, the virtual account B, and the virtual account C usually do not affect the target contest ranking of the target virtual account, so that there is no need to wait for the virtual account A, the virtual account B, and the virtual account C to end a contest of the target virtual task. Rankings of the virtual account A and the virtual account B are definitely above the ranking of the target virtual account. To improve timeliness of displaying the target contest ranking of the target virtual account, there is no need to wait for whether the virtual account A and the virtual account B end the contest of the target virtual task. For the virtual account C, because the virtual account C has satisfied the contest end condition before the target virtual account satisfies the contest end condition, when the target virtual account satisfies the contest end condition, actual battle attribute values of the virtual account C and the target virtual account can be immediately compared, thereby determining the contest ranking relationship between the virtual account C and the target virtual account, that is, a ranking order. In addition, for the virtual account D, because the target virtual task is usually affected by some uncertain factors, to ensure accuracy of displaying the target contest ranking, the final target contest ranking may be determined after the virtual account D is waited to end the contest of the target virtual task. This is not limited.

The virtual account D is most particular. Due to an uncertain factor such as equipment in the battlefield, the virtual account D may be eliminated and a health point thereof when the virtual account D is eliminated is lower than that of the target virtual account. Therefore, it is necessary to wait for the virtual account D to end the battle. This is the only situation in which the target virtual account needs to wait.

In some embodiments, in this embodiment, a process of determining the target contest ranking may be understood as, but is not limited to, estimating the contest ranking of the target virtual account in the target virtual task when the target virtual account satisfies the contest end condition. For the estimation of the target contest ranking, reference is made to the target battle attribute value of the virtual account that has not satisfied the contest end condition. Because the target battle attribute value is the minimum battle attribute value corresponding to the virtual account when the battle result thereof is a failure, when the target contest ranking is estimated by using the target battle attribute value, accuracy of the contest ranking can be ensured to the greatest extent.

In some embodiments, in this embodiment, that the target contest ranking is displayed in the prompt information triggered when the target virtual account satisfies the contest end condition may be understood as, but is not limited to, that the target contest ranking of the target virtual account is directly displayed without waiting for the target virtual task to completely end, to improve timeliness of displaying the target contest ranking.

The battle attribute value of each virtual account participating in the target virtual task is used to achieve an objective of estimating the target contest ranking of the target virtual account in the target virtual task when the target virtual account satisfies the contest end condition. In addition, the target contest ranking is estimated by using the minimum battle attribute value corresponding to the virtual account that has not satisfied the contest end condition when the battle result thereof is a failure, so that accuracy of estimating the target contest ranking is improved. In this way, before all contests of the target virtual task end, a player can obtain a more accurate target contest ranking, thereby improving timeliness of displaying the contest ranking.

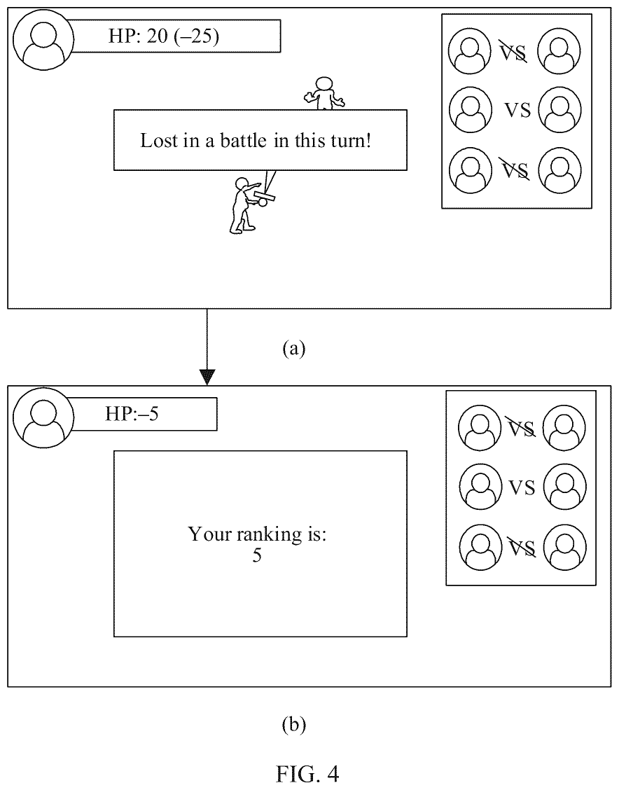

Further, for example, in some embodiments, as shown in FIG. 4, a target virtual task in which eight virtual accounts participate is run in a client. As shown in FIG. 4(a), during running of the target virtual task, when a target virtual account using the client satisfies a contest end condition (for example, “the target virtual account fails in a current turn”), battle attribute values of seven remaining virtual accounts other than the target virtual account in the eight virtual accounts are obtained. The battle attribute values of the remaining virtual accounts include a target battle attribute value of a virtual account that has not satisfied the contest end condition (that is, a virtual account that does not end a battle) in the seven virtual accounts. The battle attribute value is related to a battle result of a virtual account in the target virtual task. The contest end condition indicates that a battle attribute value of a virtual account is less than or equal to a target threshold. The target battle attribute value is a minimum battle attribute value corresponding to the virtual account when the battle result thereof is a failure. Further, as shown in FIG. 4(b), a target contest ranking of the target virtual account in the target virtual task when the target virtual account satisfies the contest end condition is determined based on the battle attribute value of each virtual account other than the target virtual account in the eight virtual accounts, and the target contest ranking (for example, “your ranking is: 5”) is displayed in prompt information triggered when the target virtual account satisfies the contest end condition.

In this embodiment of this application, the target virtual task in which the at least three virtual accounts participate is run in the client. During the running of the target virtual task, when the target virtual account using the client satisfies the contest end condition, the battle attribute values of the remaining virtual accounts other than the target virtual account in the at least three virtual accounts are obtained. The battle attribute value includes the target battle attribute value of the virtual account that has not satisfied the contest end condition in the remaining virtual accounts. The battle attribute value is related to the battle result of the corresponding virtual account in the target virtual task. The target battle attribute value is the minimum battle attribute value corresponding to the corresponding virtual account when the battle result thereof is a failure. The target contest ranking of the target virtual account in the target virtual task when the target virtual account satisfies the contest end condition is determined based on the battle attribute values. The target contest ranking is displayed in the prompt information triggered when the target virtual account satisfies the contest end condition. The battle attribute value of each virtual account participating in the target virtual task used to achieve an objective of estimating the target contest ranking of the target virtual account in the target virtual task when the target virtual account satisfies the contest end condition. In addition, the target contest ranking is estimated by using the minimum battle attribute value corresponding to the virtual account that has not satisfied the contest end condition when the battle result thereof is a failure, so that accuracy of estimating the target contest ranking is improved. In this way, before all contests of the target virtual task end, the player can obtain a more accurate target contest ranking when the player satisfies the contest end condition, thereby implementing a technical effect of improving timeliness of displaying the contest ranking.

In an exemplary solution, S206 in which the target contest ranking of the target virtual account in the target virtual task when the target virtual account satisfies the contest end condition is determined based on the battle attribute values includes the following operations.
S1: Compare the target battle attribute value with a target threshold, and determine, from the virtual account that has not satisfied the contest end condition in the remaining virtual accounts, a first virtual account whose target battle attribute value is less than or equal to the target threshold.
S2: Determine the target contest ranking based on the target battle attribute value of the first virtual account and an end battle attribute value of the target virtual account when the target virtual account satisfies the contest end condition.

In some embodiments, in this embodiment, when the target battle attribute value of the virtual account that has not satisfied the contest end condition is obtained, because the target battle attribute value is the minimum battle attribute value corresponding to the virtual account when the battle result thereof is a failure, if the target battle attribute value is also less than or equal to the target threshold, it indicates that the virtual account may also satisfy the contest end condition.

In an exemplary solution, that the target contest ranking is determined based on the target battle attribute value of the first virtual account and the end battle attribute value of the target virtual account when the target virtual account satisfies the contest end condition includes the following operations.
S1: Compare the target battle attribute value of the first virtual account with the end battle attribute value, and determine, from the first virtual account, a first target virtual account whose target battle attribute value is greater than the end battle attribute value.
S2: Determine that a contest ranking of the first target virtual account in the target virtual task is lower than a contest ranking of the target virtual account in the target virtual task.

In some embodiments, in this embodiment, the obtained target battle attribute value of the first virtual account that may satisfy the contest end condition may be understood as a battle attribute value of the first virtual account with a worst battle result. In this way, the contest ranking of the determined first target virtual account whose target battle attribute value is greater than the end battle attribute value is definitely superior to the contest ranking of the target virtual account in the target virtual task to some extent.

In an exemplary solution, S206 in which the target contest ranking of the target virtual account in the target virtual task when the target virtual account satisfies the contest end condition is determined based on the battle attribute values includes the following operations.
S1: When the remaining virtual accounts include a second virtual account that has satisfied the contest end condition, compare a battle attribute value of the second virtual account with an end battle attribute value of the target virtual account when the target virtual account satisfies the contest end condition, and determine, from the second virtual account, a second target virtual account whose battle attribute value is greater than the end battle attribute value, and a third target virtual account whose battle attribute value is less than or equal to the end battle attribute value.
S2: Determine the target contest ranking based on the battle attribute value of the second target virtual account, the battle attribute value of the third target virtual account, and the end battle attribute value.

In some embodiments, in this embodiment, when the battle attribute value of the virtual account that has satisfied the contest end condition is obtained, because the battle attribute value is the actual battle attribute value of the virtual account, the battle attribute value can be directly used to determine the target contest ranking.

In an exemplary solution, S2 in which the target contest ranking is determined based on the battle attribute value of the second target virtual account, the battle attribute value of the third target virtual account, and the end battle attribute value includes:
determining that a contest ranking of the second target virtual account in target virtual task is higher than a contest ranking of the target virtual account in the target virtual task, and determining that a contest ranking of the third target virtual account in the target virtual task is lower than or equal to the contest ranking of the target virtual account in target virtual task.

In some embodiments, in this embodiment, in a process of determining the target contest ranking by using an actual battle attribute value of the second target virtual account/third target virtual account, a contest ranking of the virtual account whose actual battle attribute value is greater than the end battle attribute value is determined to be lower than the target contest ranking, and a contest ranking of the virtual account whose actual battle attribute value is less than or equal to the end battle attribute value is determined to be higher than or equal to the target contest ranking.

In an exemplary solution, S204 in which during the running of the target virtual task, when the target virtual account using the client satisfies the contest end condition, the battle attribute values of the remaining virtual accounts other than the target virtual account in the at least three virtual accounts is obtained includes the following operations.
S1: During the running of the target virtual task, determine, when the target virtual account satisfies the contest end condition, each group of virtual accounts battling in the target virtual task, where each group of virtual accounts includes any two of the remaining virtual accounts.
S2: For a first battle virtual account and a second battle virtual account in any group of virtual accounts, obtain a battle reference value and an initial battle attribute value of the first battle virtual account, and a battle reference value and an initial battle attribute value of the second battle virtual account, where the battle reference value is for determining a battle result of one group of virtual accounts.
S3: Reduce the initial battle attribute value of the first battle virtual account based on the battle reference value of the second battle virtual account, to obtain a target battle attribute value of the first battle virtual account when the battle result is a failure, and reduce the initial battle attribute of the second battle virtual account based on the battle reference value of the first battle virtual account, to obtain a target battle attribute value of the second battle virtual account when the battle result is a failure.

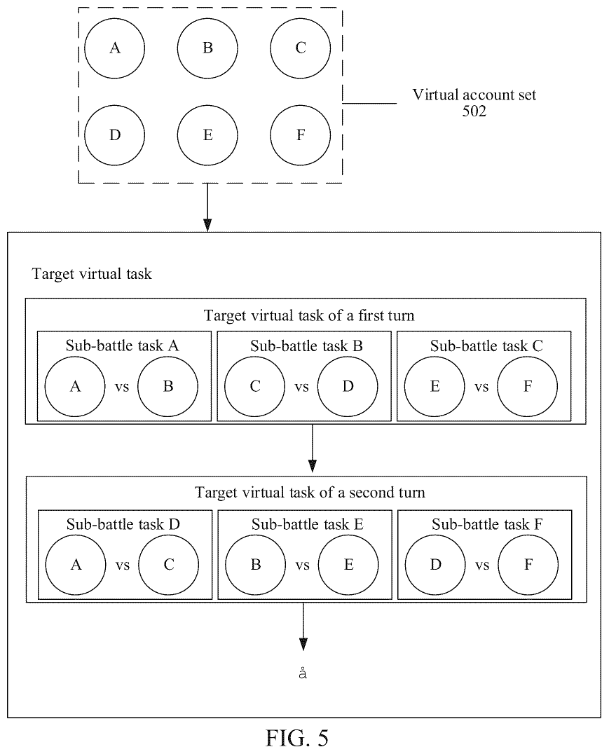

In some embodiments, in this embodiment, the running of the target virtual task may be divided into, but is not limited to, a plurality of turns, and each turn may include, but is not limited to, at least one sub-battle task. As shown in FIG. 5, a virtual account A, a virtual account B, a virtual account C, a virtual account D, a virtual account E, and a virtual account F in a virtual account set 502 are paired up to perform a first turn of battle. For example, a sub-battle task A is the virtual account A and the virtual account B, a sub-battle task B is the virtual account C and the virtual account D, and a sub-battle task C is the virtual account E and the virtual account F. Further, based on a battle result of the target virtual task of the first turn, running of a second turn of the target virtual task continues. For example, a sub-battle task D is the virtual account A and the virtual account C, a sub-battle task E is the virtual account B and the virtual account E, and a sub-battle task F is the virtual account D and the virtual account F.

Further, for example, in some embodiments, during the running of the target virtual task, when a battle virtual account satisfies the contest end condition, each group of virtual accounts battling in the target virtual task is determined. Each group of virtual accounts includes, for example, any two of the virtual accounts other than the battle virtual account in the virtual account set 502 (at least three virtual accounts) shown in FIG. 5. A battle reference value and an initial battle attribute value that are of a first battle virtual account in each group of virtual accounts are obtained, and a battle reference value and an initial battle attribute value that are of a second battle virtual account in each group of virtual accounts are obtained. The battle reference value is for determining a battle result of one group of virtual accounts. The initial battle attribute value of the first battle virtual account in each group of virtual accounts is reduced based on the battle reference value of the second battle virtual account in the same group of virtual accounts, to obtain a target battle attribute value of the first battle virtual account in each group of virtual accounts when the battle result thereof is a failure. The initial battle attribute of the second battle virtual account in each group of virtual accounts is reduced based on the battle reference value of the first battle virtual account in the same group of virtual accounts, to obtain a target battle attribute value of the second battle virtual account in each group of virtual accounts when the battle result thereof is a failure.

In this embodiment of this application, during the running of the target virtual task, when the battle virtual account satisfies the contest end condition, each group of virtual accounts battling in the target virtual task is determined. Each group of virtual accounts includes any two of the remaining virtual accounts. The battle reference value and the initial battle attribute value that are of the first battle virtual account in each group of virtual accounts are obtained, and the battle reference value and the initial battle attribute value that are of the second battle virtual account in each group of virtual accounts are obtained. The battle reference value is for determining the battle result of one group of virtual accounts. The initial battle attribute value of the first battle virtual account in each group of virtual accounts is reduced based on the battle reference value of the second battle virtual account in the same group of virtual accounts, to obtain the target battle attribute value of the first battle virtual account in each group of virtual accounts when the battle result thereof is a failure. The initial battle attribute of the second battle virtual account in each group of virtual accounts is reduced based on the battle reference value of the first battle virtual account in the same group of virtual accounts, to obtain the target battle attribute value of the second battle virtual account in each group of virtual accounts when the battle result thereof is a failure. In this way, a technical effect of improving accuracy of determining a target contest ranking is implemented.

In an exemplary solution, after S202 in which the target virtual task in which the at least three virtual accounts participate is run in the client, the method includes the following operations.
S1: Determine, based on the battle reference value of the first battle virtual account in each group of virtual accounts and the battle reference value of the second battle virtual account in each group of virtual accounts, a battle winner account whose battle result is a success and a battle loser account whose battle result is a failure that are in each group of virtual accounts, post-battle reference information of the battle winner account in each group of virtual accounts, and post-battle reference information of the battle loser account in each group of virtual accounts, where the post-battle reference information is reference information remained after the battle reference value is consumed in a battle.
S2: Reduce an initial battle attribute value of the battle loser account in each group of virtual accounts base on the post-battle reference information of the battle winner account in each group of virtual accounts, to obtain an actual battle attribute of the battle loser account in each group of virtual accounts.
S3: Determine that a virtual account whose actual battle attribute value is less than or equal to a target threshold satisfies the contest end condition.

In some embodiments, in this embodiment, the battle attribute value is related to the battle result of the virtual account in the target virtual task. For example, when the battle result of the virtual account is a failure, the battle attribute value of the virtual account is reduced, to obtain the actual battle attribute, or when the battle result of the virtual account is a success, the battle attribute value of the virtual account is unchanged or increased, to obtain the actual battle attribute.

The battle winner account whose battle result is a success and the battle loser account whose battle result is a failure that are in each group of virtual accounts, the post-battle reference information of the battle winner account in each group of virtual accounts, and the post-battle reference information of the battle loser account in each group of virtual accounts are determined based on the battle reference value of the first battle virtual account in each group of virtual accounts and the battle reference value of the second battle virtual account in each group of virtual accounts. The post-battle reference information is the reference information remained after the battle reference value is consumed in the battle. The initial battle attribute value of the battle loser account in each group of virtual accounts is reduced base on the post-battle reference information of the battle winner account in each group of virtual accounts, to obtain the actual battle attribute of the battle loser account in each group of virtual accounts. A virtual account whose actual battle attribute value is less than or equal to the target threshold is determined to satisfy the contest end condition.

Further, for example, in some embodiments, to obtain a target battle attribute value of a virtual account A, a battle object of the virtual account A is first determined to be a virtual account B. Then before a battle between the virtual account A and the virtual account B ends, it is assumed that a battle result of the virtual account A is a failure, a target attribute value of the virtual account B is further obtained, and a quantity of battle attribute values are determined based on the target attribute value. Then the quantity of battle attribute values are deducted from an initial battle attribute value of the virtual account A to obtain the target battle attribute value of the virtual account A. To determine a limit value of the target battle attribute value, when the target attribute value may be consumed due to the battle, it may be assumed, but is not limited to, that the target attribute value is not consumed, and then the target battle attribute value of the virtual account A is determined based on the target attribute value that is not consumed, to obtain the limit value of the target battle attribute value.

Specifically, it is assumed that five virtual objects controlled by the virtual account A is to battle with two virtual objects controlled by the virtual account B. Until all virtual objects of one party are eliminated, the party is determined to be a losing party, and a target quantity of battle attribute values of the losing party are deducted. The target quantity may be but is not limited to a remaining quantity of virtual objects controlled by a winner party. In some embodiments, as shown in FIG. 3(a), the initial battle attribute value of the virtual account A is 2, and an initial battle attribute value of the virtual account B is 1. Further, as shown in FIG. 3(b), the target battle attribute value of the virtual account A may be determined as 0 (2−2=0), and a target battle attribute value of the virtual account B may be determined as −4 (1−5=−4).

In this embodiment of this application, the battle winner account whose battle result is a success and the battle loser account whose battle result is a failure that are in each group of virtual accounts, the post-battle reference information of the battle winner account in each group of virtual accounts, and the post-battle reference information of the battle loser account in each group of virtual accounts are determined based on the battle reference value of the first battle virtual account in each group of virtual accounts and the battle reference value of the second battle virtual account in each group of virtual accounts, where the post-battle reference information is the reference information remained after the battle reference value is consumed in the battle. The initial battle attribute value of the battle loser account in each group of virtual accounts is reduced base on the post-battle reference information of the battle winner account in each group of virtual accounts, to obtain the actual battle attribute of the battle loser account in each group of virtual accounts. A virtual account whose actual battle attribute value is less than or equal to the target threshold is determined to satisfy the contest end condition. In this way, a technical effect of improving accuracy of the target contest ranking is implemented.

In an exemplary solution, that the target virtual task in which the at least three virtual accounts participate is run in the client includes:
running, in the client, the target virtual task in which at least three virtual objects participate, where each of the at least three virtual accounts controls at least one of the virtual objects.

In some embodiments, in this embodiment, the target virtual task may be divided into, but is not limited to, a preparation stage and a battle stage. The preparation stage is configured for configuring and preparing a to-be-battled virtual object, and the battle stage is configured for controlling or passively controlling the virtual object to battle.

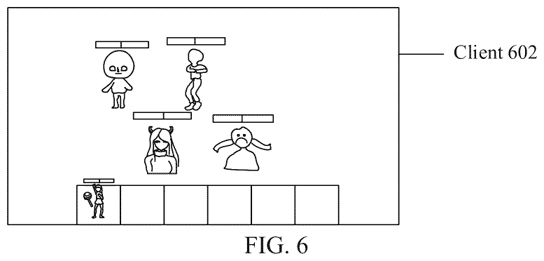

Further, for example, in some embodiments, as shown in FIG. 6, a target virtual task in which at least three virtual objects participate is run in a client 602, where each of the at least three virtual accounts controls at least one of the virtual objects.

In an exemplary solution, S206 in which the target contest ranking of the target virtual account in the target virtual task when the target virtual account satisfies the contest end condition is determined based on the battle attribute values includes the following operations.
S1: Simulate a battle situation of a remaining virtual object based on the battle attribute value, to obtain a simulated battle result of the remaining virtual object.
S2: Determine a simulated contest ranking of the remaining virtual account based on the simulated battle result.
S3: Adjust a contest ranking of the target virtual account in the target virtual task based on the simulated contest ranking, to obtain the target contest ranking.

In some embodiments, in this embodiment, because many uncertain factors exist in the target virtual task, the contest ranking of the virtual account in the target virtual task may be simulated based on, but is not limited to, the many factors in the target virtual task. However, an error may exist in the simulation. To reduce an impact of the error on a user, the target contest ranking may be, but is not limited to, a range of contest rankings, for example, from the third place to the fifth place.

In an exemplary solution, that the battle situation of the remaining virtual object is simulated based on the battle attribute value to obtain the simulated battle result of the remaining virtual object includes:
when the battle attribute value includes a plurality of battle attribute values, simulating the battle situation of the remaining virtual object by using an average battle attribute value of the plurality of battle attribute values, to obtain the simulated battle result; or simulating the battle situation of the remaining virtual object by using a limit battle attribute value having a maximum or a minimum value in the plurality of battle attribute values, to obtain the simulated battle result.

In an exemplary solution, S204 in which during the running of the target virtual task, when the target virtual account using the client satisfies the contest end condition, the battle attribute values of the remaining virtual accounts other than the target virtual account in the at least three virtual accounts is obtained includes the following operations.
during the running of the target virtual task, obtaining, when the target virtual account is eliminated, the battle attribute values of the remaining virtual accounts, where the battle attribute value includes at least one of the following: a control attribute value of a virtual account other than the target virtual account in the at least three virtual accounts, and a battle attribute value of a virtual object controlled by the virtual account other than the target virtual account in the at least three virtual accounts.

In some embodiments, in this embodiment, the control attribute value of the virtual account may be understood as, but is not limited to, an attribute value of a factor that can be actively or passively controlled by the virtual account, such as a skill attribute of an active skill that can be manually triggered by the virtual account, or an account addition attribute of the virtual account. The battle attribute value of the virtual object controlled by the virtual account may be understood as, but is not limited to, an attribute value of a battle factor of the virtual object, such as an object attribute, a skill attribute, or an equipment attribute (a probability of fiercely attacking, an attack power, and a defense power) of the virtual object.

In an exemplary solution, that the target virtual task in which the at least three virtual accounts participate is run in the client includes: running, in the client, a virtual sub-task of a current turn, where the target virtual task includes at least one turn of virtual sub-task.

In an exemplary solution, after the target contest ranking is displayed in the prompt information triggered when the target virtual account satisfies the contest end condition, the method includes: displaying, when the at least one turn of virtual sub-task ends, a contest ranking of each of the at least three virtual accounts in the target virtual task.

The virtual sub-task of the current turn is run in the client, where the target virtual task includes at least one turn of virtual sub-task. When the at least one turn of virtual sub-task ends, the contest ranking of each of the at least three virtual accounts is displayed in the target virtual task.

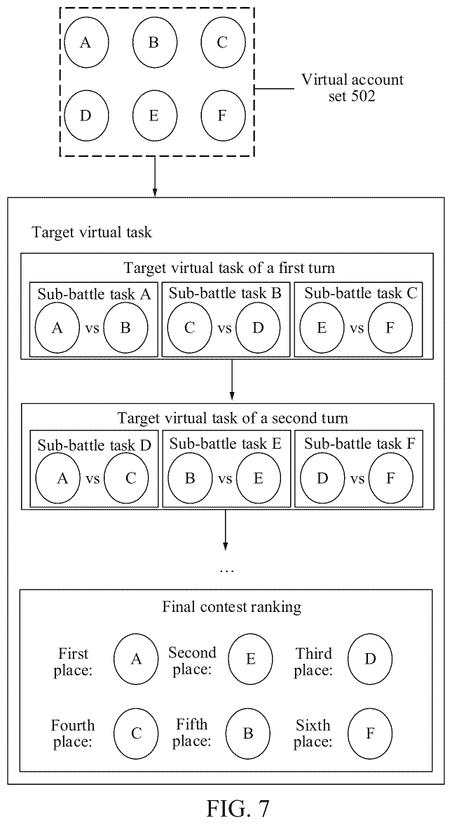

Further, for example, in some embodiments, based on a scenario shown in FIG. 5, still as shown in FIG. 7, a sub-battle task (virtual sub-task) of a current turn is run in a client, where a target virtual task includes at least one turn of virtual sub-task. When the at least one turn of virtual sub-task ends, a final contest ranking of each of at least three virtual accounts is displayed in the target virtual task.

In an exemplary solution, in some embodiments, for case of understanding, the foregoing method for displaying a contest ranking is applied to an auto chess-type virtual game. The auto chess-type virtual game may be, but is not limited to, an in-round trading hero card eight-player turn-based arena game. There are totally eight players in the game, and each of the players occupies a chessboard. Each turn includes a preparation stage and a battle stage. In the preparation stage, the players purchase chess pieces (heroes) in a store, and plan and arrange the chess pieces on the chessboard. After the players enter the battle stage, lineups for two parties are determined, and the chess pieces automatically battle until all chess pieces of one party are eliminated. A health point of a losing party is deducted. A turn is constantly repeated to pair a new opponent. Until a health value of a player is less than or equal to 0, the player is considered to be eliminated from the game. A last remaining player finally wins the game (the first place). Rankings (the second place to the eighth place) of other players are determined based on health points remained when the other players are eliminated.

In some embodiments, in this embodiment, the ranking is calculated in advance based on a limit deducted health point, and waiting for an ineffective battle result is avoided, thereby reducing waiting duration of the player after the player is eliminated, ensuring reliability of the ranking, and improving smoothness of experience of the entire contest. For the limit deducted health point, it is assumed that an initial health point of each player is 100. After a battle result of each turn is determined, a health point of the losing party is deducted. A specific value of the deducted health point depends on a quantity of remaining chess pieces, a level, a particular skill, and the like of the winner. Because the lineups of the two parties for battling are determined, a system may calculate a maximum possible deducted health point (limit deducted health point) in advance, and a health value of the player after the limit deducted health point is deducted is referred to as a “limit minimum health point”.

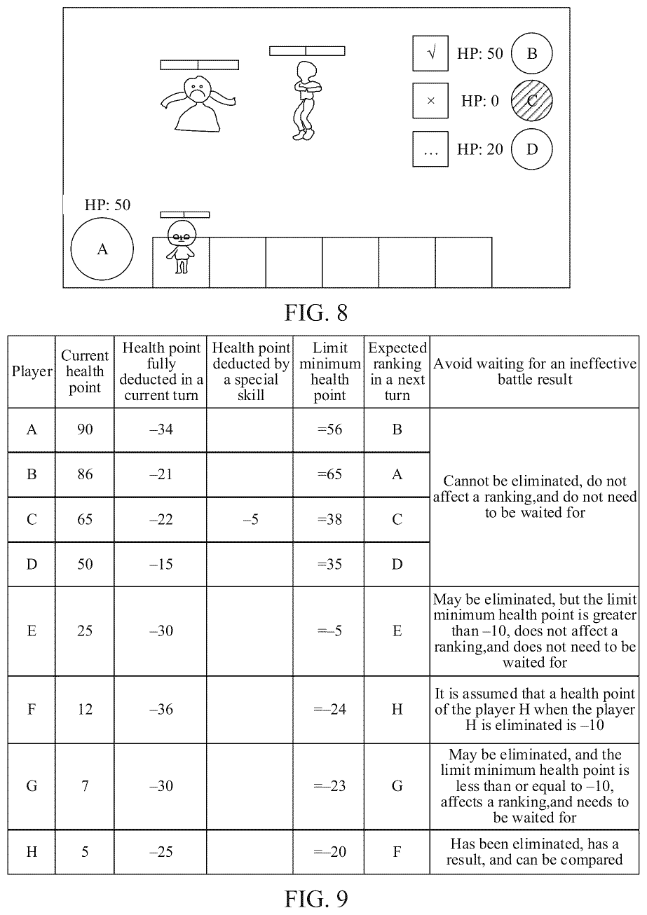

Further, in some embodiments, a display interface of a client shown in FIG. 8 is used as an example. A right side of the display interface is a player status bar, and information such as avatars, nicknames, and current health values of three players are displayed. A symbol “√” represents that a player wins a current turn. A symbol “x” represents that a player loses the current turn and a health point thereof is deducted. A symbol “ . . . ” represents that a player is still in the battle. When an avatar becomes shaded, it represents that a player has been eliminated (a health value is less than or equal to 0) and is eliminated for the game.

It is assumed that a player A loses a current turn. After a health point is deducted, a health value satisfies −50, it is determined that the player A is eliminated. However, in this case, one player is still in the battle, and whether the player wins or loses has not been determined. Therefore, a center of a battle interface may display, but is not limited to, a prompt of “waiting for the battle to end . . . ”, and the player A cannot operate until whether all players win or lose in the current turn is determined. An advantage of this design is that accuracy of a ranking can be ensured. In theory, only after whether all other players win or lose is determined, and a health point of a losing party is deducted, accurate sorting can be performed based on a health value remained in this case, to determine a ranking of the eliminated player A. However, this design also has a disadvantage. After being eliminated, the player is usually eager to obtain a settlement result, to restart a next round or continue to watch the current round. A waiting link after elimination interrupts the operation of the player A, causing damage to smoothness of experience. In particular, when the other players are in a stalemate in the battle, the player A may need to wait for long duration, and the experience is extremely poor.

Further, in this embodiment, a ranking of an eliminated player is determined after all battles end. However, from a perspective of a game numerical design, lineups of both parties of each turn are actually determined, and impact of equipment and skills may also be estimated. A system may pre-calculate limit minimum health points of all players in the current turn, to obtain an expected ranking. Among the other players on a field, a player whose limit minimum health point is higher than the health point of the player A when the player A is eliminated does not affect the ranking of the player A, and this player definitely ranks above the player A. Therefore, the player A does not need to wait for this player to end the battle. In view of this, this embodiment optimizes a waiting mechanism after elimination in a current auto chess-type virtual game, to reduce a sense of interruption during the game, thereby providing better experience for the player.

Further, for example, in some embodiments, as shown in FIG. 9, it is assumed that there are eight players: a player A, a player B, a player C, a player D, a player E, a player F, a player G, and a player H, where the player H represents a player of a client. After a previous turn of battle, health values of the eight players are lost to different degrees (Refer to a “current health point”). The player H is on the verge of elimination (the “current health point” is only 5), and is probably eliminated in a current turn.

Because this embodiment is an optimization for the waiting mechanism after elimination, it is assumed herein that the player H is eliminated in the current turn, and a health point thereof when the player His eliminated is −10. In this case, it is assumed that all players encounter a most disastrous situation (that is, most health points are deducted): all chess pieces are defeated by an opponent and none of chess pieces of the opponent is eliminated (that is, “health point being fully deducted”), and the health point is further consumed, to a maximum extent, by a special skill carried by the opponent (that is, a “limit health point being deducted by the special skill”). A minimum health point (that is, a “limit minimum health point”) of another player in the current turn may be obtained based on the following calculation formula:

Limit minimum health point=current health point−fully deducted health point−limit health point deducted by a special skill.

After limit minimum health points of the other players are calculated, an expected ranking of the player in a next turn may be obtained based on a principle that “a lower limit minimum health point indicates a lower ranking”.

It can be learned from content shown in FIG. 9 that, limit minimum health points of the player B, the player A, the player C, and the player D are greater than 0. In other words, the four players cannot be eliminated in the current turn, and an actual ranking of the player H is not affected. Therefore, the player H does not need to wait for the four players. A limit minimum health point of the player E is less than or equal to 0, indicating that the player E may be eliminated in the current turn. However, the limit minimum health point is −5>−10 (that is, even if the player E dies, a health point thereof cannot be lower than the health point of the player H when the player H is eliminated). Therefore, the player E also does not affect the ranking of the player H, and the player H does not need to wait for the player E to end the battle.

Limit minimum health points of the player G and the player F are less than or equal to 0 and less than −10 (that is, the two players may die and have lower health points than the health point of the player H when the player H is eliminated). The ranking of the player H when the player H is eliminated is affected. Therefore, the player H needs to wait for the two players to end the battle. In FIG. 9, a situation in which the player G is eliminated early than the player H in the current turn is assumed. In this case, a health value of the player G when the player G is eliminated is determined, and the health points of the two players may be immediately compared to determine a ranking order. In this case, the player H does not need to wait for the player G.

In conclusion, the player H only needs to wait for a player who satisfies three conditions simultaneously: (1) the player may be eliminated in the current turn, (2) a limit minimum health point of the player in the current turn is lower than the health point of the player H when the player H is eliminated, and (3) the player is still in the battle. Based on the principle, waiting for an ineffective battle result is avoided, a waiting link after elimination of the player is greatly shortened or even removed, and experience for the player is improved.

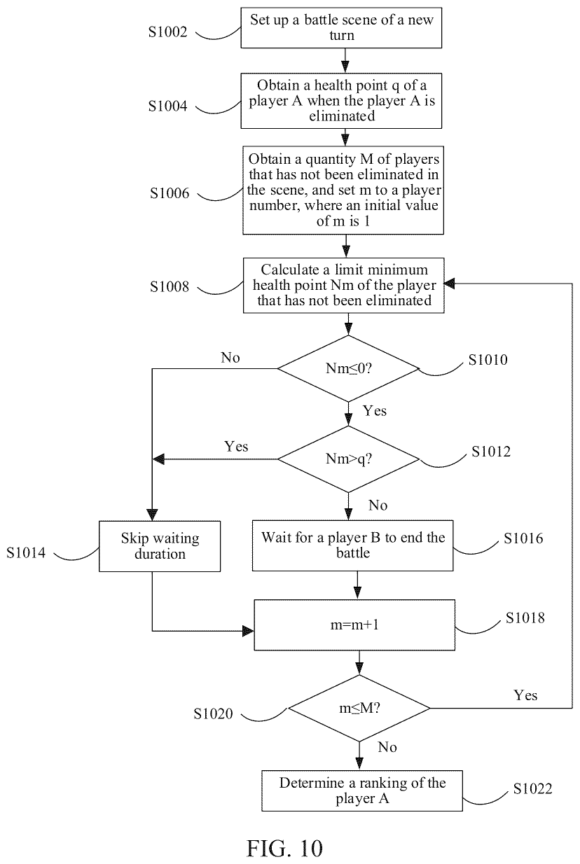

In some embodiments, in this embodiment, an execution process of the foregoing method for displaying a contest ranking is shown in FIG. 10. Specific operations are as follows:
Operation S1002: After a new turn of a game starts, match an opponent, and set up a battle scene.
Operation S1004: Obtain, as a battle progresses, a health point q of a player A when the player A is eliminated. It is assumed that all chess pieces of the player A are eliminated, a health point of the player A is deduced, causing the health point q being less than or equal to 0, and the player A is determined to be eliminated.
Operation S1006: Obtain a quantity M of players that has not been eliminated in the scene, and set m to a player number, where an initial value of m is 1. Because the game is an eight-player game, it can be learned that there are at most seven players surviving on a field, that is, 1≤M≤7. m is further set, to represent a number of a surviving player, and an initial value of m is 1, where m≤M. A logic layer of a game client starts to calculate, in sequence, limit minimum health points Nm of the surviving players on the field. Because the initial value of m is 1, a limit minimum health point N1 of a surviving player with a number 1 is first calculated.
Operation S1008: Calculate the limit minimum health point Nm of the player that has not been eliminated.
Operation S1010: Determine whether Nm≤0. If yes, an operation S1012 is performed, or if no, it indicates that the player cannot be eliminated in the current turn, and a ranking of the player A is not affected. Therefore, the player is skipped, and an operation S1014 is performed.
Operation S1012: Determine whether Nm>q. If yes, it indicates that even if the player is eliminated in the current turn, a health point thereof cannot be lower than the health point of the player A when the player A is eliminated, and the ranking of the player A is not affected. Therefore, the player is also skipped, and operation S1014 is performed. If no, the player A needs to wait for the player to end the battle, that is, an operation S1016 is performed.
Operation S1014: Skip waiting duration.
Operation S1016: Wait for a player B to end the battle.
Operation S1018: m=m+1, and assign a value of m+1 to m, that is, start to calculate the limit minimum health point Nm of a next player.
Operation S1020: Determine whether m≤M. If yes, operation S1008 is performed, or if no, an operation S1022 is performed.
Operation S1022: Determine the ranking of the player A.

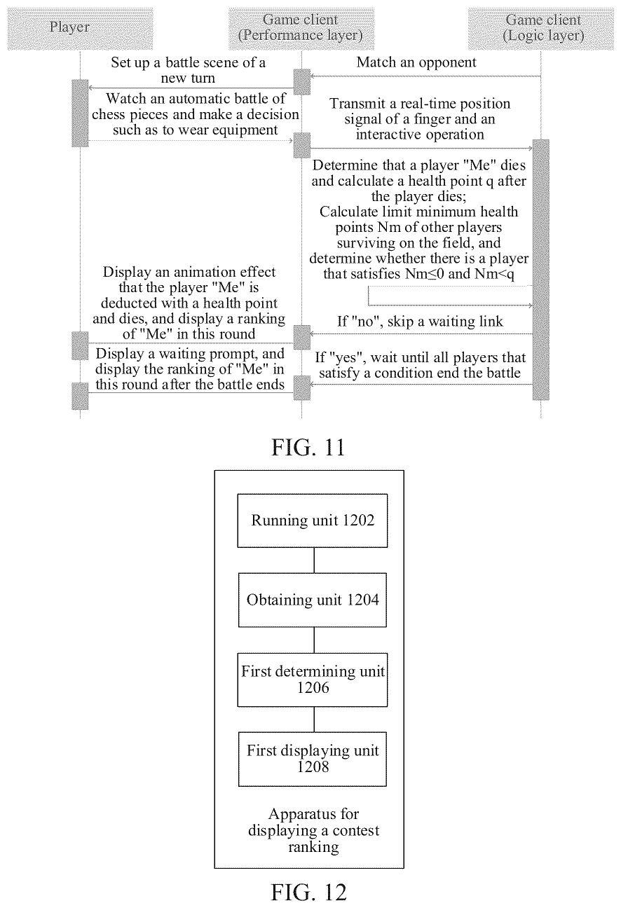

Further, for example, FIG. 11 is a diagram of a specific time sequence among a player, a performance layer of a game client, and a logic layer of the game client in this embodiment. A new turn of a game starts, an opponent is matched on the logical layer, and the performance layer sets up a battle scene. The player watches an automatic battle of chess pieces and makes a decision such as to wear equipment. The performance layer transmits a real-time position signal of a finger and an interactive operation to the logic layer. As the battle progresses, all chess pieces of the player are eliminated, and a health point of the player is deducted. As a result, a health point q≤0, and the player is determined by the logic layer to be eliminated. The logic layer calculates the health point q of the player when the player is eliminated, and calculates a quantity M of other players surviving on the field in this case. Then the logic layer starts to calculate, in sequence, limit minimum health points Nm (m represents a player number) of the other players surviving on the field. The logic layer determines whether there is a player that satisfies Nm≤0 and Nm<q. If “no”, it indicates that battle results of all the other surviving players on the field do not affect a ranking of the player. Therefore, a waiting link is skipped. The performance layer displays an animation effect that the player is deducted with the health point and eliminated, and then displays the ranking of the player in this round. If “yes”, it indicates that there is another player on the field that may affect the ranking the player. The performance layer displays a waiting prompt, and displays the ranking of the player in this round after all players that satisfy the condition end the battle.

In a specific implementation of this application, relevant data such as user information is involved. When the foregoing embodiments of this application are applied to a specific product or technology, user permission or user agreement is required, and collection, use and processing of the relevant data need to comply with relevant laws, regulations, and standards of relevant countries and regions.

For ease of description, the foregoing method embodiments are described as combinations of a series of actions. However, a person skilled in the art is to know that, this application is not limited to any described order of the actions, because some operations may be performed in another order or simultaneously according to this application. In addition, a person skilled in the art is to also know that, all the embodiments described in the specification are preferred embodiments, and the related actions and modules are not necessarily mandatory to this application.

According to another aspect of embodiments of this application, an apparatus for displaying a contest ranking and configured to perform the foregoing method for displaying a contest ranking is further provided. As shown in FIG. 12, the apparatus includes:
a running unit 1202, configured to run, in a client, a target virtual task in which at least three virtual accounts participate;
an obtaining unit 1204, configured to, during running of the target virtual task, obtain, when a target virtual account using the client satisfies a contest end condition, battle attribute values of remaining virtual accounts other than the target virtual account in the at least three virtual accounts, where the battle attribute values include a target battle attribute value of a virtual account that has not satisfied the contest end condition in the remaining virtual accounts, the battle attribute value is related to a battle result of a corresponding virtual account in the target virtual task, and the target battle attribute value is a minimum battle attribute value corresponding to the corresponding virtual account when a battle result thereof is a failure;
a first determining unit 1206, configured to determine, based on the battle attribute values, a target contest ranking of the target virtual account in the target virtual task when the target virtual account satisfies the contest end condition; and
a first displaying unit 1208, configured to display the target contest ranking in prompt information triggered when the target virtual account satisfies the contest end condition.

For specific embodiments, refer to the example shown in the foregoing method for displaying a contest ranking, and details are described in this example.

In this embodiment of this application, the target virtual task in which the at least three virtual accounts participate is run in the client. During the running of the target virtual task, when the target virtual account using the client satisfies the contest end condition, the battle attribute values of the remaining virtual accounts other than the target virtual account in the at least three virtual accounts are obtained. The battle attribute value includes the target battle attribute value of the virtual account that has not satisfied the contest end condition in the remaining virtual accounts, the battle attribute value is related to the battle result of the corresponding virtual account in the target virtual task, and the target battle attribute value is the minimum battle attribute value corresponding to the corresponding virtual account when the battle result thereof is a failure. The target contest ranking of the target virtual account in the target virtual task when the target virtual account satisfies the contest end condition is determined based on the battle attribute values. The target contest ranking is displayed in the prompt information triggered when the target virtual account satisfies the contest end condition. The battle attribute value of each virtual account participating in the target virtual task used to achieve an objective of estimating the target contest ranking of the target virtual account in the target virtual task when the target virtual account satisfies the contest end condition. In addition, the target contest ranking is estimated by using the minimum battle attribute value corresponding to the virtual account that has not satisfied the contest end condition when the battle result thereof is a failure, so that accuracy of estimating the target contest ranking is improved. In this way, before all contests of the target virtual task end, the player can obtain a more accurate target contest ranking when the player satisfies the contest end condition, thereby implementing a technical effect of improving timeliness of displaying the contest ranking.

In an exemplary solution, the first determining unit 1206 includes:
a first determining module, configured to compare the target battle attribute value with a target threshold, and determine, from the virtual account that has not satisfied the contest end condition in the remaining virtual accounts, a first virtual account whose target battle attribute value is less than or equal to the target threshold; and
a second determining module, configured to determine the target contest ranking based on the target battle attribute value of the first virtual account and an end battle attribute value of the target virtual account when the target virtual account satisfies the contest end condition.

For specific embodiments, refer to the example shown in the foregoing method for displaying a contest ranking, and details are not described in this example.

In an exemplary solution, the second determining module includes:
a first determining sub-module, configured to compare the target battle attribute value of the first virtual account with the end battle attribute value, and determine, from the first virtual account, a first target virtual account whose target battle attribute value is greater than the end battle attribute value; and
a second determining sub-module, configured to determine that a contest ranking of the first target virtual account in the target virtual task is lower than a contest ranking of the target virtual account in the target virtual task.

For specific embodiments, refer to the example shown in the foregoing method for displaying a contest ranking, and details are not described in this example.

In an exemplary solution, the first determining unit 1206 includes:
a third determining module, configured to, when the remaining virtual accounts include a second virtual account that has satisfied the contest end condition, compare a battle attribute value of the second virtual account with an end battle attribute value of the target virtual account when the target virtual account satisfies the contest end condition, and determine, from the second virtual account, a second target virtual account whose battle attribute value is greater than the end battle attribute value, and a third target virtual account whose battle attribute value is less than or equal to the end battle attribute value; and
a fourth determining module, configured to determine the target contest ranking based on the battle attribute value of the second target virtual account, the battle attribute value of the third target virtual account, and the end battle attribute value.

For specific embodiments, refer to the example shown in the foregoing method for displaying a contest ranking, and details are not described in this example.

In an exemplary solution, the fourth determining module includes:
a third determining sub-module, configured to determine that a contest ranking of the second target virtual account in target virtual task is higher than a contest ranking of the target virtual account in the target virtual task, and determine that a contest ranking of the third target virtual account in the target virtual task is lower than or equal to the contest ranking of the target virtual account in target virtual task.

For specific embodiments, refer to the example shown in the foregoing method for displaying a contest ranking, and details are not described in this example.

In an exemplary solution, the obtaining unit 1204 includes:
a fifth determining module, configured to, during the running of the target virtual task, determine, when the target virtual account satisfies the contest end condition, each group of virtual accounts battling in the target virtual task, where each group of virtual accounts includes any two of the remaining virtual accounts;
a first obtaining module, configured to, for a first battle virtual account and a second battle virtual account in any group of virtual accounts, obtain a battle reference value and an initial battle attribute value of the first battle virtual account, and a battle reference value and an initial battle attribute value of the second battle virtual account, where the battle reference value is for determining a battle result of one group of virtual accounts; and
a second obtaining module, configured to reduce the initial battle attribute value of the first battle virtual account based on the battle reference value of the second battle virtual account, to obtain a target battle attribute value of the first battle virtual account when the battle result is a failure, and reduce the initial battle attribute of the second battle virtual account based on the battle reference value of the first battle virtual account, to obtain a target battle attribute value of the second battle virtual account when the battle result is a failure.

For specific embodiments, refer to the example shown in the foregoing method for displaying a contest ranking, and details are not described in this example.

In an exemplary solution, the apparatus includes:
a second determining unit, configured to, after the target virtual task in which the at least three virtual accounts participate is run in the client, determine, based on the battle reference value of the first battle virtual account in each group of virtual accounts and the battle reference value of the second battle virtual account in each group of virtual accounts, a battle winner account whose battle result is a success and a battle loser account whose battle result is a failure that are in each group of virtual accounts, post-battle reference information of the battle winner account in each group of virtual accounts, and post-battle reference information of the battle loser account in each group of virtual accounts, where the post-battle reference information is reference information remained after the battle reference value is consumed in a battle;
a reducing unit, configured to, after the target virtual task in which the at least three virtual accounts participate is run in the client, reduce an initial battle attribute value of the battle loser account in each group of virtual accounts base on the post-battle reference information of the battle winner account in each group of virtual accounts, to obtain an actual battle attribute of the battle loser account in each group of virtual accounts; and
a third determining unit, configured to, after the target virtual task in which the at least three virtual accounts participate is run in the client, determine that a virtual account whose actual battle attribute value is less than or equal to a target threshold satisfies the contest end condition.

For specific embodiments, refer to the example shown in the foregoing method for displaying a contest ranking, and details are not described in this example.

In an exemplary solution, the running unit 1202 includes:
a first running module, configured to run, in the client, the target virtual task in which at least three virtual objects participate, where each of the at least three virtual accounts controls at least one of the virtual objects.

For specific embodiments, refer to the example shown in the foregoing method for displaying a contest ranking, and details are not described in this example.

In an exemplary solution, the first determining unit 1206 includes:
a third obtaining module, configured to simulate a battle situation of a remaining virtual object based on the battle attribute value, to obtain a simulated battle result of the remaining virtual object;
a fourth obtaining module, configured to determine a simulated contest ranking of the remaining virtual account based on the simulated battle result; and
an adjustment module, configured to adjust a contest ranking of the target virtual account in the target virtual task based on the simulated contest ranking, to obtain the target contest ranking.

For specific embodiments, refer to the example shown in the foregoing method for displaying a contest ranking, and details are not described in this example.

In an exemplary solution, the third obtaining module includes:
a first obtaining sub-module, configured to, when the battle attribute value includes a plurality of battle attribute values, simulate the battle situation of the remaining virtual object by using an average battle attribute value of the plurality of battle attribute values, to obtain the simulated battle result; or a second obtaining sub-module, configured to simulate the battle situation of the remaining virtual object by using a limit battle attribute value having a maximum or a minimum value in the plurality of battle attribute values, to obtain the simulated battle result.

For specific embodiments, refer to the example shown in the foregoing method for displaying a contest ranking, and details are not described in this example.

In an exemplary solution, the obtaining unit 1204 includes:
a fifth obtaining module, configured to, during the running of the target virtual task, obtain, when the target virtual account is eliminated, the battle attribute values of the remaining virtual accounts, where the battle attribute value includes at least one of the following: a control attribute value of a virtual account other than the target virtual account in the at least three virtual accounts, and a battle attribute value of a virtual object controlled by the virtual account other than the target virtual account in the at least three virtual accounts.

For specific embodiments, refer to the example shown in the foregoing method for displaying a contest ranking, and details are not described in this example.

In an exemplary solution, the running unit 1202 includes: a second running module, configured to run, in the client, a virtual sub-task of a current turn, where the target virtual task includes at least one turn of virtual sub-task; and
the apparatus includes: a second display unit, configured to, after the target contest ranking is displayed in the prompt information triggered when the target virtual account satisfies the contest end condition, display, when the at least one turn of virtual sub-task ends, a contest ranking of each of the at least three virtual accounts in the target virtual task.

For specific embodiments, refer to the example shown in the foregoing method for displaying a contest ranking, and details are not described in this example.

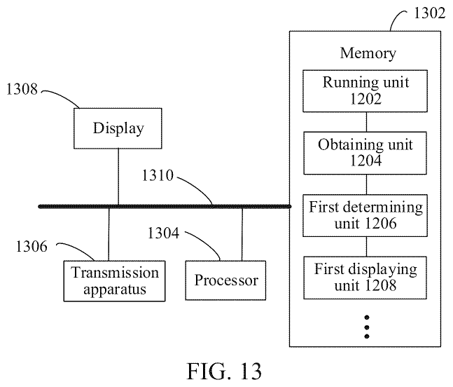

According to still another aspect of embodiments of this application, an electronic device for performing the foregoing method for displaying a contest ranking is further provided. As shown in FIG. 13, the electronic device includes a memory 1302 and a processor 1304. The memory 1302 has a computer program stored therein, and the processor 1304 is configured to perform operations in any one of the foregoing method embodiments through the computer program.

In some embodiments, in this embodiment, the electronic device may be located in at least one of a plurality of network devices in a computer network.

In some embodiments, in this embodiment, the processor may be configured to perform the following operations through the computer program.
S1: Run, in a client, a target virtual task in which at least three virtual accounts participate.
S2: During running of the target virtual task, obtain, when a target virtual account using the client satisfies a contest end condition, battle attribute values of remaining virtual accounts other than the target virtual account in the at least three virtual accounts, where the battle attribute values include a target battle attribute value of a virtual account that has not satisfied the contest end condition in the remaining virtual accounts, the battle attribute value is related to a battle result of a corresponding virtual account in the target virtual task, and the target battle attribute value is a minimum battle attribute value corresponding to the corresponding virtual account when a battle result thereof is a failure.
S3: Determine, based on the battle attribute values, a target contest ranking of the target virtual account in the target virtual task when the target virtual account satisfies the contest end condition.
S4: Display the target contest ranking in prompt information triggered when the target virtual account satisfies the contest end condition.

In some embodiments, a person of ordinary skill in the art may understand that, the structure shown in FIG. 13 is only an example. The electronic device may be a terminal device such as a smartphone (for example, an Android mobile phone or an iOS mobile phone), a tablet computer, a palmtop computer, a mobile Internet device (MID), or a PAD. FIG. 13 does not limit the structure of the electronic device. For example, the electronic device may further include more or fewer components (such as a network interface) than those shown in FIG. 13, or has a configuration different from that shown in FIG. 13.

The memory 1302 may be configured to store a software program and a module, for example, program instructions/modules corresponding to the method and apparatus for displaying a contest ranking in embodiments of this application. The processor 1304 runs the software program and the module stored in the memory 1302, to implement various functional applications and data processing, that is, implement the foregoing method for displaying a contest ranking. The memory 1302 may include a high speed random access memory, and may also include a non-volatile memory, for example, one or more magnetic storage apparatuses, a flash memory, or another non-volatile solid-state memory. In some embodiments, the memory 1302 may further include memories remotely disposed relative to the processor 1304, and the remote memories may be connected to a terminal through a network. Examples of the network include, but are not limited to, the Internet, an intranet, a local area network, a mobile communication network, and a combination thereof. The memory 1302 may be specifically configured to, but is not limited to, store information such as a target virtual task, a battle attribute value, and a target contest ranking. For example, as shown in FIG. 13, the memory 1302 may include, but is not limited to, the running unit 1202, the obtaining unit 1204, the first determining unit 1206, and the first displaying unit 1208 that are in the foregoing apparatus for displaying a contest ranking. In addition, the memory 1302 may include, but is not limited to, another module unit in the foregoing apparatus for displaying a contest ranking, and details are not described in this example.

In some embodiments, a transmission apparatus 1306 is configured to receive or send data through a network. Specific examples of the network may include a wired network and a wireless network. In an example, the transmission apparatus 1306 includes a network interface controller (NIC), and the network interface controller may be connected to another network device and a router through a network cable, to communicate with the Internet or a local area network. In an example, the transmission apparatus 1306 is a radio frequency (RF) module, and is configured to communicate with the Internet in a wireless manner.

In addition, the foregoing electronic device further includes: a display 1308, configured to display the information such as the target virtual task, the battle attribute value, and the target contest ranking; and a connection bus 1310, configured to connect module parts in the electronic device.

In another embodiment, the foregoing terminal device or server may be a node in a distributed system. The distributed system may be a blockchain system, and the blockchain system may be a distributed system formed by connecting a plurality of nodes in a form of network communication. The nodes may form a peer to peer (P2P) network, and any form of computing device, for example, the electronic device such as the server or the terminal, may become a node in the blockchain system by joining the peer to peer network.

According to an aspect of this application, a computer program product is provided. The computer program product includes a computer program, and the computer program includes program code configured for performing the method shown in the flowchart. In such an embodiment, the computer program may be downloaded and installed from a network through a communication part, and/or installed from a removable medium. When the computer program is executed by a central processing unit, functions provided in this embodiment of this application are executed.

Sequence numbers of the foregoing embodiments of this application are merely for description purpose but do not indicate the preference of the embodiments.

A computer system of the electronic device is merely an example, and does not constitute any limitation on functions and use ranges of embodiments of this application.

The computer system includes a central processing unit (CPU). The CPU may perform various appropriate actions and processing based on a program stored in a read-only memory (ROM) or a program loaded from a storage portion into a random access memory (RAM). The random access memory further stores various programs and data required for operating the system. The central processing unit, the read-only memory, and the random access memory are connected to each other through a bus. An input/output (I/O) interface is also connected to the bus.

The following components are connected to the input/output interface: an input part including a keyboard, a mouse, or the like, an output part including a cathode ray tube (CRT), a liquid crystal display (LCD), a speaker, or the like, a storage part including a hard disk, or the like, and a communication part including a network interface card such as a local area network or a modem. The communication part performs communication processing by using a network such as the Internet. A drive is also connected to the input/output interface as required. A removable medium, such as a magnetic disk, an optical disc, a magneto-optical disk, or a semiconductor memory, is installed on the drive as required, so that a computer program read from the removable medium is installed into the storage part as required.

Particularly, according to embodiments of this application, the processes described in the method flowcharts may be implemented as computer software programs. For example, an embodiment of this application includes a computer program product, the computer program product includes a computer program carried on a computer-readable medium, and the computer program includes program code configured for performing the method shown in the flowchart. In such an embodiment, the computer program may be downloaded and installed from a network through a communication part, and/or installed from a removable medium. When the computer program is executed by a central processing unit, functions limited in a system of this application are executed.

According to an aspect of this application, a non-transitory computer-readable storage medium is provided. A processor of a computer device reads a computer program from the computer-readable storage medium. The processor executes the computer program to enable the computer device to perform the method provided in the foregoing optional implementations.

In some embodiments, in this embodiment, a person of ordinary skill in the art may understand that all or part of the operations of the methods in the foregoing embodiments may be implemented by a program instructing hardware relevant to a terminal device. The program may be stored in a computer-readable storage medium, and the storage medium may include: a flash drive, a read-only memory, a random access memory, a magnetic disk, an optical disc, and the like.

Sequence numbers of the foregoing embodiments of this application are merely for description purpose but do not indicate the preference of the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this application essentially, or the part contributing to a conventional technology, or all or some of the technical solutions may be implemented in a form of a software product. The computer software product is stored in a storage medium and includes several instructions used to enable one or more computer devices (which may be a personal computer, a server, a network device, or the like) to perform all or some of the operations of the methods described in embodiments of this application.

In the foregoing embodiments of this application, descriptions of the embodiments have different emphases. For a part that is not described in detail in one embodiment, refer to related descriptions in other embodiments.

In the several embodiments provided in this application, the disclosed client may be implemented in another manner. The described apparatus embodiment is merely exemplary. For example, the unit division is merely logical function division and may have other division manners in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the units or modules may be implemented in electronic or other forms.

The units described as separate parts may or may not be physically separate, and parts displayed as units may or may not be physical units, may be located in one position, or may be distributed on a plurality of network units. A part of or all of the units may be selected based on an actual need to achieve the objectives of the solutions of the embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software function unit.

In this application, the term “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely preferred implementations of this application. A person of ordinary skill in the art may further make several improvements and modifications without departing from the principle of this application. These improvements and modifications shall fall within the protection scope of this application.

What is claimed is:

1. A method for displaying a contest ranking performed by a computer device, the method comprising:
running a target virtual task of a contest in which at least three virtual accounts participate, the at least three virtual account including a target virtual account controlled by a user of the computer device;
withdrawing the target virtual account from participating the target virtual task after determining that the target virtual account satisfies a contest end condition;
obtaining battle attribute values of remaining virtual accounts other than the target virtual account of the at least three virtual accounts still participating in the target virtual task, wherein each battle attribute value corresponds to a current battle result of a corresponding virtual account participating in the target virtual task;
before any of the remaining virtual accounts satisfies the contest end condition:
determining, based on the battle attribute values of the remaining virtual accounts, a target contest ranking of the target virtual account in the target virtual task; and
displaying the target contest ranking of the target virtual account to the user of the computer device.

2. The method according to claim 1, wherein each of the remaining virtual accounts has a minimum battle attribute corresponding to a lowest possible battle attribute value when the virtual account satisfies the contest end condition.

3. The method according to claim 2, wherein the determining, based on the battle attribute values of the remaining virtual accounts, a target contest ranking of the target virtual account in the target virtual task comprises:
determining, among the remaining virtual accounts, a first virtual account whose minimum battle attribute value is less than or equal to a target threshold; and
determining the target contest ranking based on the minimum battle attribute value of the first virtual account and an end battle attribute value of the target virtual account when the target virtual account satisfies the contest end condition.

4. The method according to claim 3, wherein the determining the target contest ranking based on the minimum battle attribute value of the first virtual account and an end battle attribute value of the target virtual account when the target virtual account satisfies the contest end condition comprises:
determining that the first target virtual account has a contest ranking lower than that of the target virtual account in the target virtual task when the minimum battle attribute value of the first virtual account is greater than the end battle attribute value of the target virtual account.

5. The method according to claim 2, wherein the determining, based on the battle attribute values of the remaining virtual accounts, a target contest ranking of the target virtual account in the target virtual task comprises:
after one of the remaining virtual accounts has satisfied the contest end condition:
determining, among the remaining virtual accounts, a second target virtual account whose battle attribute value is greater than the end battle attribute value, and a third target virtual account whose battle attribute value is less than or equal to the end battle attribute value; and
determining the target contest ranking based on the battle attribute value of the second target virtual account, the battle attribute value of the third target virtual account, and the end battle attribute value.

6. The method according to claim 5, wherein the determining the target contest ranking based on the battle attribute value of the second target virtual account, the battle attribute value of the third target virtual account, and the end battle attribute value comprises:
determining that a contest ranking of the second target virtual account in the target virtual task is higher than a contest ranking of the target virtual account in the target virtual task, and determining that a contest ranking of the third target virtual account in the target virtual task is lower than or equal to the contest ranking of the target virtual account in the target virtual task.

7. The method according to claim 1, wherein the obtaining battle attribute values of remaining virtual accounts other than the target virtual account of the at least three virtual accounts still participating in the target virtual task comprises:
determining each group of virtual accounts battling in the target virtual task, wherein each group of virtual accounts comprises any two of the remaining virtual accounts;
for a first battle virtual account and a second battle virtual account in any group of virtual accounts, obtaining a battle reference value and an initial battle attribute value of the first battle virtual account, and a battle reference value and an initial battle attribute value of the second battle virtual account; and
reducing the initial battle attribute value of the first battle virtual account based on the battle reference value of the second battle virtual account, to obtain a target battle attribute value of the first battle virtual account when the first battle virtual account satisfies the contest end condition, and reducing the initial battle attribute of the second battle virtual account based on the battle reference value of the first battle virtual account, to obtain a target battle attribute value of the second battle virtual account when the second battle virtual account satisfies the contest end condition.

8. A computer device, comprising a memory and a processor, the memory having a computer program stored therein, and the processor, when executed by the processor, causing the computer device to perform a method for displaying a contest ranking, the method including:
running a target virtual task of a contest in which at least three virtual accounts participate, the at least three virtual account including a target virtual account controlled by a user of the computer device;
withdrawing the target virtual account from participating the target virtual task after determining that the target virtual account satisfies a contest end condition;
obtaining battle attribute values of remaining virtual accounts other than the target virtual account of the at least three virtual accounts still participating in the target virtual task, wherein each battle attribute value corresponds to a current battle result of a corresponding virtual account participating in the target virtual task;
before any of the remaining virtual accounts satisfies the contest end condition:
determining, based on the battle attribute values of the remaining virtual accounts, a target contest ranking of the target virtual account in the target virtual task; and
displaying the target contest ranking of the target virtual account to the user of the computer device.

9. The computer device according to claim 8, wherein each of the remaining virtual accounts has a minimum battle attribute corresponding to a lowest possible battle attribute value when the virtual account satisfies the contest end condition.

10. The computer device according to claim 9, wherein the determining, based on the battle attribute values of the remaining virtual accounts, a target contest ranking of the target virtual account in the target virtual task comprises:
determining, among the remaining virtual accounts, a first virtual account whose minimum battle attribute value is less than or equal to a target threshold; and
determining the target contest ranking based on the minimum battle attribute value of the first virtual account and an end battle attribute value of the target virtual account when the target virtual account satisfies the contest end condition.

11. The computer device according to claim 10, wherein the determining the target contest ranking based on the minimum battle attribute value of the first virtual account and an end battle attribute value of the target virtual account when the target virtual account satisfies the contest end condition comprises:
determining that the first target virtual account has a contest ranking lower than that of the target virtual account in the target virtual task when the minimum battle attribute value of the first virtual account is greater than the end battle attribute value of the target virtual account.

12. The computer device according to claim 9, wherein the determining, based on the battle attribute values of the remaining virtual accounts, a target contest ranking of the target virtual account in the target virtual task comprises:
after one of the remaining virtual accounts has satisfied the contest end condition:
determining, among the remaining virtual accounts, a second target virtual account whose battle attribute value is greater than the end battle attribute value, and a third target virtual account whose battle attribute value is less than or equal to the end battle attribute value; and
determining the target contest ranking based on the battle attribute value of the second target virtual account, the battle attribute value of the third target virtual account, and the end battle attribute value.

13. The computer device according to claim 12, wherein the determining the target contest ranking based on the battle attribute value of the second target virtual account, the battle attribute value of the third target virtual account, and the end battle attribute value comprises:
determining that a contest ranking of the second target virtual account in the target virtual task is higher than a contest ranking of the target virtual account in the target virtual task, and determining that a contest ranking of the third target virtual account in the target virtual task is lower than or equal to the contest ranking of the target virtual account in the target virtual task.

14. The computer device according to claim 8, wherein the obtaining battle attribute values of remaining virtual accounts other than the target virtual account of the at least three virtual accounts still participating in the target virtual task comprises:
determining each group of virtual accounts battling in the target virtual task, wherein each group of virtual accounts comprises any two of the remaining virtual accounts;
for a first battle virtual account and a second battle virtual account in any group of virtual accounts, obtaining a battle reference value and an initial battle attribute value of the first battle virtual account, and a battle reference value and an initial battle attribute value of the second battle virtual account; and
reducing the initial battle attribute value of the first battle virtual account based on the battle reference value of the second battle virtual account, to obtain a target battle attribute value of the first battle virtual account when the first battle virtual account satisfies the contest end condition, and reducing the initial battle attribute of the second battle virtual account based on the battle reference value of the first battle virtual account, to obtain a target battle attribute value of the second battle virtual account when the second battle virtual account satisfies the contest end condition.

15. A non-transitory computer-readable storage medium, comprising a stored computer program, the computer program, when being executed by a processor of a computer device, causing the computer device to perform a method for displaying a contest ranking, the method including:
running a target virtual task of a contest in which at least three virtual accounts participate, the at least three virtual account including a target virtual account controlled by a user of the computer device;
withdrawing the target virtual account from participating the target virtual task after determining that the target virtual account satisfies a contest end condition;
obtaining battle attribute values of remaining virtual accounts other than the target virtual account of the at least three virtual accounts still participating in the target virtual task, wherein each battle attribute value corresponds to a current battle result of a corresponding virtual account participating in the target virtual task;
before any of the remaining virtual accounts satisfies the contest end condition:
determining, based on the battle attribute values of the remaining virtual accounts, a target contest ranking of the target virtual account in the target virtual task; and
displaying the target contest ranking of the target virtual account to the user of the computer device.

16. The non-transitory computer-readable storage medium according to claim 15, wherein each of the remaining virtual accounts has a minimum battle attribute corresponding to a lowest possible battle attribute value when the virtual account satisfies the contest end condition.

17. The non-transitory computer-readable storage medium according to claim 16, wherein the determining, based on the battle attribute values of the remaining virtual accounts, a target contest ranking of the target virtual account in the target virtual task comprises:
determining, among the remaining virtual accounts, a first virtual account whose minimum battle attribute value is less than or equal to a target threshold; and
determining the target contest ranking based on the minimum battle attribute value of the first virtual account and an end battle attribute value of the target virtual account when the target virtual account satisfies the contest end condition.

18. The non-transitory computer-readable storage medium according to claim 17, wherein the determining the target contest ranking based on the minimum battle attribute value of the first virtual account and an end battle attribute value of the target virtual account when the target virtual account satisfies the contest end condition comprises:
determining that the first target virtual account has a contest ranking lower than that of the target virtual account in the target virtual task when the minimum battle attribute value of the first virtual account is greater than the end battle attribute value of the target virtual account.

19. The non-transitory computer-readable storage medium according to claim 16, wherein the determining, based on the battle attribute values of the remaining virtual accounts, a target contest ranking of the target virtual account in the target virtual task comprises:
after one of the remaining virtual accounts has satisfied the contest end condition:
determining, among the remaining virtual accounts, a second target virtual account whose battle attribute value is greater than the end battle attribute value, and a third target virtual account whose battle attribute value is less than or equal to the end battle attribute value; and
determining the target contest ranking based on the battle attribute value of the second target virtual account, the battle attribute value of the third target virtual account, and the end battle attribute value.

20. The non-transitory computer-readable storage medium according to claim 15, wherein the obtaining battle attribute values of remaining virtual accounts other than the target virtual account of the at least three virtual accounts still participating in the target virtual task comprises:
determining each group of virtual accounts battling in the target virtual task, wherein each group of virtual accounts comprises any two of the remaining virtual accounts;
for a first battle virtual account and a second battle virtual account in any group of virtual accounts, obtaining a battle reference value and an initial battle attribute value of the first battle virtual account, and a battle reference value and an initial battle attribute value of the second battle virtual account; and
reducing the initial battle attribute value of the first battle virtual account based on the battle reference value of the second battle virtual account, to obtain a target battle attribute value of the first battle virtual account when the first battle virtual account satisfies the contest end condition, and reducing the initial battle attribute of the second battle virtual account based on the battle reference value of the first battle virtual account, to obtain a target battle attribute value of the second battle virtual account when the second battle virtual account satisfies the contest end condition.
